(19) United States
(12) Patent Application Publication
(10) Pub. No.: US 2026/0150173 A1
(43) Pub. Date: May 28, 2026

(54) X-Ray Fluorescence Spectrometer and Power Supply Apparatus Used Therefor

(71) Applicant: SHIMADZU CORPORATION, Kyoto-shi (JP)

(72) Inventor: Yohei UKAI, Kyoto-shi (JP)

(21) Appl. No.: 19/178,479

(22) Filed: Apr. 14, 2025

(30) Foreign Application Priority Data
Apr. 12, 2024 (JP) 2024-064431

(51) Int. Cl. H05G 1/26; H05G 1/10; H05G 1/54

(52) U.S. Cl. CPC H05G 1/265; H05G 1/10; H05G 1/54

(57) ABSTRACT

An X-ray fluorescence spectrometer includes an X-ray tube, a detector, a power supply apparatus, and a control circuit. The X-ray tube irradiates a sample with primary X-rays. The detector detects secondary X-rays generated from the sample. The power supply apparatus includes a high-voltage power supply unit and a detection circuit. The detection circuit detects voltage variation in a high-voltage circuit including the X-ray tube. The detection circuit includes a first resistive element having one end connected to a ground potential, a plurality of second resistive elements connected in series between the other end of the first resistive element and a power feed line, a plurality of capacitors connected in parallel to the second resistive elements, respectively, and a high-pass filter connected to the other end of the first resistive element. The control circuit detects occurrence of electric discharge in the high-voltage circuit based on a signal from the detection circuit.

### CROSS REFERENCE TO RELATED APPLICATIONS

This nonprovisional application is based on Japanese Patent Application No. 2024-064431 filed with the Japan Patent Office on Apr. 12, 2024, the entire contents of which are hereby incorporated by reference.

### BACKGROUND OF THE INVENTION

### Field of the Invention

The present disclosure relates to an X-ray fluorescence spectrometer and a power supply apparatus used therefor, and more specifically to detection of electric discharge in a power supply apparatus used in the X-ray fluorescence spectrometer.

### Description of the Background Art

An X-ray fluorescence spectrometer that irradiates a sample with X-rays and analyzes the sample with fluorescent X-rays generated from the sample has conventionally been known. Such an X-ray spectrometer uses an X-ray generator as disclosed in Japanese Patent Laying-Open No. 2010-212072. In the X-ray generator, X-rays are generated by application of a tube voltage to an X-ray tube including a cathode electrode and a target electrode.

### SUMMARY OF THE INVENTION

In the X-ray generator, in application of a boosted high voltage to the X-ray tube, unintended electric discharge may often occur in a high-voltage circuit including the X-ray tube. When electric discharge occurs, a current excessively larger than a current within a range of normal use instantaneously flows in a circuit, which may become a factor for deterioration and failure of the X-ray tube or a power supply apparatus that applies a high voltage to the X-ray tube.

In order to prevent such deterioration and failure due to electric discharge, the X-ray generator is generally provided with an overcurrent protection circuit for protection of a circuit against an overcurrent generated by electric discharge. When electric discharge at a level undetectable by an overcurrent detection mechanism included in the overcurrent protection circuit occurs, however, the generator may be kept used without a protection operation being performed by the protection circuit. Then, intermittent occurrence of electric discharge undetectable by the overcurrent detection mechanism may lead to accelerated deterioration of the power supply apparatus or the X-ray tube and resultant failure.

A threshold value for detection of the overcurrent in the overcurrent detection mechanism can also be lowered in order to enhance detection sensitivity. Excessive lowering in threshold value, however, may lead to a malfunction of the protection circuit due to variation in current in a normal operation range. Though a response speed of the overcurrent protection circuit may be increased, increase in response speed may increase possibility of the malfunction of the protection circuit due to influence by variation in load or noise.

As other measures for detection of generation of the overcurrent, the overcurrent may also indirectly be detected based on detection of lowering in high output voltage at the time of electric discharge. In this case, a differentiation circuit composed of a resistor and a capacitor is generally used for detection of lowering in voltage. In this case, however, the differentiation circuit should be connected to a high-voltage line, and a high breakdown voltage capacitor is required as the capacitor used for the differentiation circuit. Therefore, component cost of the capacitor increases and cost for mounting and cost for an insulating molding material may also increase. Addition of the capacitor increases also a size of the power supply apparatus.

The present disclosure was made to solve such problems, and an object thereof is to improve accuracy in detection of electric discharge while avoiding increase in cost in an analysis apparatus including an X-ray generator.

An X-ray fluorescence spectrometer according to a first aspect of the present disclosure includes an X-ray tube, a detector, a power supply apparatus, and a control circuit. The X-ray tube includes a filament and a target and irradiates a sample with primary X-rays. The detector is configured to detect secondary X-rays generated from the sample. The power supply apparatus is configured to apply a tube voltage to the target. The control circuit is configured to detect occurrence of electric discharge in a high-voltage circuit including the X-ray tube. The power supply apparatus includes a high-voltage power supply unit configured to generate the tube voltage, a power feed line through which the tube voltage is transmitted from the high-voltage power supply unit to the target, and a detection circuit connected to the power feed line. The detection circuit is configured to detect voltage variation in the X-ray tube. The detection circuit includes a first resistive element having one end connected to a ground potential, a plurality of second resistive elements connected in series between the other end of the first resistive element and the power feed line, a plurality of capacitors connected in parallel to the plurality of second resistive elements, respectively, and a high-pass filter connected to the other end of the first resistive element. The control circuit is configured to detect occurrence of electric discharge in the high-voltage circuit based on a signal from the detection circuit.

A power supply apparatus according to a second aspect of the present disclosure applies a tube voltage to an X-ray tube including a filament and a target. The power supply apparatus includes a high-voltage power supply unit configured to generate the tube voltage, a power feed line through which the tube voltage is transmitted from the high-voltage power supply unit to the target, and a detection circuit connected to the power feed line. The detection circuit is configured to detect voltage variation in a high-voltage circuit including the X-ray tube. The detection circuit includes a first resistive element having one end connected to a ground potential, a plurality of second resistive elements connected in series between the other end of the first resistive element and the power feed line, a plurality of capacitors connected in parallel to the plurality of second resistive elements, respectively, a high-pass filter connected to the other end of the first resistive element, and a comparator configured to compare a signal having passed through the high-pass filter with a reference value.

The foregoing and other objects, features, aspects, and advantages of this invention will become more apparent from the following detailed description of this invention when taken in conjunction with the accompanying drawings.

### BRIEF DESCRIPTION OF THE DRAWINGS

FIG. 1 is a diagram schematically showing a power supply apparatus and an X-ray tube of an X-ray fluorescence spectrometer according to an embodiment.

FIG. 2 is a diagram showing details of a detection circuit in FIG. 1.

FIG. 3 is a functional block diagram of a control circuit in FIG. 1.

FIG. 4 is a flowchart of electric discharge detection processing performed in the control circuit.

FIG. 5 is a diagram for illustrating a region where a discharging voltage is detected in the detection circuit in FIG. 1.

FIG. 6 is a diagram showing details of a detection circuit in a first modification.

FIG. 7 is a diagram showing details of a detection circuit in a second modification.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### EMBODIMENT

### Configuration of X-ray Fluorescence Spectrometer

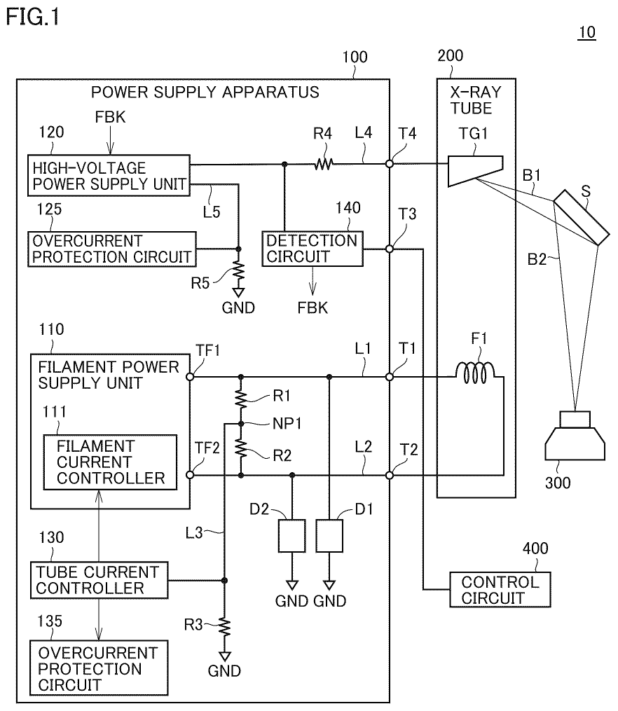

FIG. 1 is a diagram schematically showing an X-ray fluorescence spectrometer according to an embodiment. An X-ray fluorescence spectrometer 10 is, for example, an energy dispersive X-ray fluorescence spectrometer (EDX). In the present embodiment, an example will be described in which X-ray fluorescence spectrometer 10 includes a power supply apparatus 100 that generates primary X-rays.

As shown in FIG. 1, X-ray fluorescence spectrometer 10 includes power supply apparatus 100, an X-ray tube, 200, a detector 300, and a control circuit 400. Power supply apparatus 100 applies a voltage to X-ray tube 200 to excite primary X-rays B1. A sample S is irradiated with primary X-rays B1. Sample S irradiated with primary X-rays B1 emits X-ray fluorescence B2. X-ray fluorescence B2 emitted from sample S is referred to as “secondary X-rays” in relation to primary X-rays. Detector 300 detects X-ray fluorescence B2. X-ray fluorescence spectrometer 10 can thus conduct quantitative analysis and/or qualitative analysis of sample S. Though FIG. 1 shows control circuit 400 as an element separate from power supply apparatus 100, all or at least one of functions of control circuit 400 may be included in power supply apparatus 100 or a high-voltage power supply unit 120.

A target TG1 and a filament F1 are arranged inside X-ray tube 200. Target TG1 is an anode and filament F1 is a cathode. In X-ray tube 200, target TG1 and filament F1 are arranged at a distance from each other. Power supply apparatus 100 includes a filament power supply unit 110, high-voltage power supply unit 120, a tube current controller 130, overcurrent protection circuits 125 and 135, and a detection circuit 140.

Filament power supply unit 110 supplies a current to filament F1 to heat filament F1. The current supplied from filament power supply unit 110 to filament F1 is referred to as a “filament current” in the description below.

High-voltage power supply unit 120 applies a high voltage to target TG1 in X-ray tube 200. The high voltage applied by high-voltage power supply unit 120 is referred to as a “tube voltage” in the description below. High-voltage power supply unit 120 boosts using a rectifier, a converter, a Cockcroft-Walton circuit (none of which is shown), or the like, a direct-current (DC) voltage converted from a commercial power supply to generate the high voltage.

High-voltage power supply unit 120 is connected to target TG1 through a power line L4 via a resistor R4 provided in power line L4. In addition, high-voltage power supply unit 120 is connected to a ground potential GND through a power line L5 and a resistor R5. In X-ray tube 200, thermions are generated by heating of filament F1 by filament power supply unit 110. Generated thermions are moved toward target TG1 by the tube voltage applied by high-voltage power supply unit 120 across filament F1 and target TG1, and ultimately impinge on target TG1. As a result of this impingement of thermions, primary X-rays B1 are excited.

Filament power supply unit 110 is connected to filament F1 through a power line L1 and a power line L2. Power line L1 is connected to a terminal TF1 of filament power supply unit 110 and a terminal T1 of power supply apparatus 100. Power line L2 is connected to a terminal TF2 of filament power supply unit 110 and a terminal T2 of power supply apparatus 100. Terminal T1 is connected to one end of filament F1 and terminal T2 is connected to the other end of filament F1.

A resistor R1 and a resistor R2 are connected in series between power line L1 and power line L2. One end of a power line L3 is connected to a connection node NP1 between power line L1 and power line L2. The other end of power line L3 is connected to ground potential GND via a resistor R3. One end of power line L3 may be connected to any one of power line L1 and power line L2 instead of connection node NP1.

A protection circuit D1 including a Zener diode is connected between power line L1 and ground potential GND. Similarly, a protection circuit D2 including a Zener diode is connected between power line L2 and ground potential GND. Protection circuits D1 and D2 are circuits for protecting filament power supply unit 110 and tube current controller 130, in case of occurrence of electric discharge in X-ray tube 200, against an excessively large current generated by the electric discharge.

Tube current controller 130 carries out feedback control of an output current from filament power supply unit 110 based on a current flowing through power line L3. More specifically, tube current controller 130 detects the tube current flowing through power line L3 by converting with resistor R3, the tube current into a voltage value. Tube current controller 130 transmits a detection value of the tube current to a filament current controller 111 and overcurrent protection circuit 135.

Filament power supply unit 110 adjusts a filament current based on the tube current detected by tube current controller 130. Overcurrent protection circuit 135 is configured to determine whether or not an overcurrent occurs based on comparison between a current value detected by tube current controller 130 and a threshold value and to stop output from high-voltage power supply unit 120 when the overcurrent occurs.

Similarly, overcurrent protection circuit 125 arranged on an output side of high-voltage power supply unit 120 detects the current flowing through power line L5 by converting the current into a voltage value with resistor R5. Overcurrent protection circuit 125 stops output from high-voltage power supply unit 120 when an overcurrent state continues for a certain period.

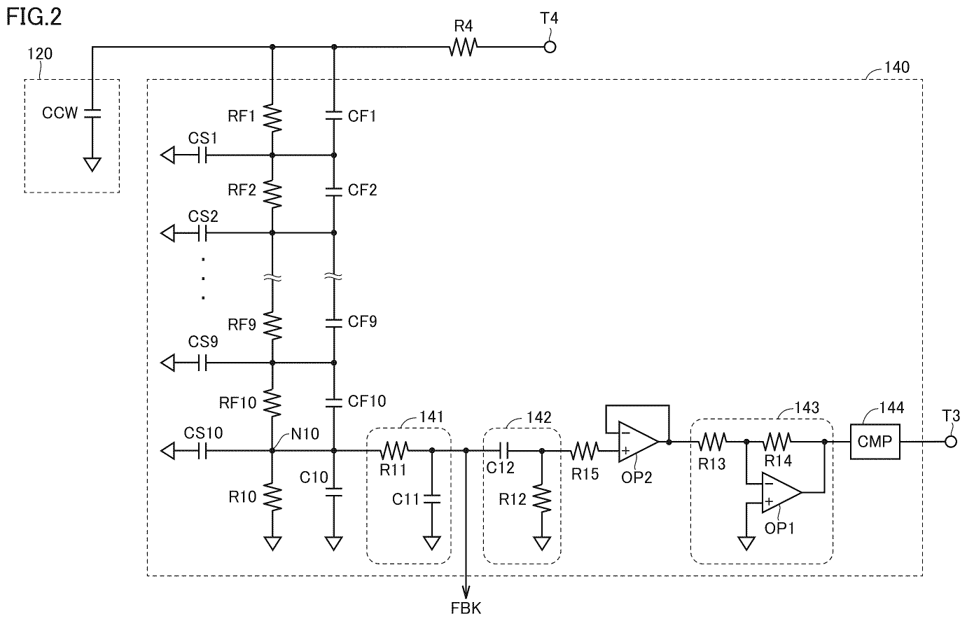

Detection circuit 140 is connected to power line L4 and configured to detect a voltage applied to power line L4. As will be described later with reference to FIG. 2, detection circuit 140 steps down the voltage applied to power line L4 with a plurality of resistors connected in series and detects variation in step-down voltage. Detection circuit 140 is connected to control circuit 400 at a terminal T3 in power supply apparatus 100. Control circuit 400 detects occurrence of electric discharge in a high-voltage circuit including X-ray tube 200 based on variation in voltage detected by detection circuit 140. The high-voltage circuit is a collective denotation of circuits to which a high voltage outputted from high-voltage power supply unit 120 is applied, and includes high-voltage power supply unit 120 and power line L4 in addition to X-ray tube 200.

Equipment including an X-ray generator, such as an X-ray fluorescence spectrometer, is generally provided with an overcurrent protection circuit for protection of a circuit against an overcurrent generated by electric discharge as described above. When electric discharge at a level undetectable by an overcurrent detection mechanism included in the overcurrent protection circuit occurs, however, the generator may be kept used without a protection operation being performed by the protection circuit. Then, intermittent occurrence of electric discharge undetectable by the overcurrent detection mechanism may consequently lead to deterioration and failure of the power supply apparatus or the X-ray tube.

In order to detect such electric discharge, a threshold value for detection of the overcurrent in the overcurrent detection mechanism can also be lowered to enhance detection sensitivity. Excessive lowering in threshold value, however, may lead to erroneous detection due to variation in current in a normal operation range and a malfunction of the protection circuit. Though a response speed of the overcurrent protection circuit may be increased, increase in response speed may increase possibility of the malfunction of the protection circuit due to influence by variation in load or noise.

As other measures for detection of generation of the overcurrent, the overcurrent may also be detected based on detection of lowering in high output voltage at the time of electric discharge. In this case, a differentiation circuit composed of a resistor and a capacitor is generally used for detection of lowering in voltage. In this case, however, the differentiation circuit should be connected to a high-voltage line. If such a circuit is individually added to a conventional circuit, a high breakdown voltage capacitor is required as the capacitor used for the differentiation circuit. Therefore, component cost of the capacitor increases and cost for mounting and cost for an insulating molding material or the like may also increase. Addition of the capacitor also increases a size of a power supply apparatus.

Then, X-ray fluorescence spectrometer 10 in the present embodiment is provided with detection circuit 140 that detects voltage variation in power line L4 on an output side of high-voltage power supply unit 120, in addition to conventional overcurrent protection circuit 125. By providing this detection circuit 140, abnormality due to output short-circuiting can be detected by overcurrent protection circuit 125 and electric discharge that instantaneously occurs can be detected by detection circuit 140. In particular in the present embodiment, as will be described later with reference to FIG. 2, detection circuit 140 is constructed of an existing feedback circuit for voltage control of high-voltage power supply unit 120, and hence a desired function can be performed with fewer additional components relatively more inexpensively than in an example where detection circuit 140 is separately provided.

### Configuration of Detection Circuit

FIG. 2 is a diagram showing details of detection circuit 140 in FIG. 1. Referring to FIG. 2, detection circuit 140 includes resistors R10 and RF1 to RF10, capacitors C10 and CF1 to CF10, a low-pass filter 141, a high-pass filter 142, an amplifier 143, a comparator (CMP) 144, a resistor R15, and an operational amplifier OP2. Capacitors shown with CS1 to CS10 in FIG. 2 schematically represent parasitic capacitances produced between the respective resistors and ground potential GND, and no physical element is actually arranged.

Resistors RF1 to RF10 and resistor R10 are connected in series in this order between power line L4 and ground potential GND. Resistors RF1 to RF10 are resistors for reduction of the voltage applied to power line L4. Resistor R10 is voltage division resistor R10 for setting a voltage at a connection node N10 between resistor RF10 and resistor R10.

Connection node N10 is connected to terminal T3 for output to detection circuit 140, with low-pass filter 141, high-pass filter 142, resistor R15, operational amplifier OP2, amplifier 143, and comparator 144 being interposed.

In order to make the current flowing through resistors RF1 to RF10 sufficiently smaller than the current flowing through power line L4 to improve efficiency of high-voltage power supply unit 120, a resistance value of each of resistors RF1 to RF10 should be set to achieve a high resistance. By way of example, by setting the resistance value of each of resistors RF1 to RF10 to 200 MΩ and setting the resistance value of resistor R10 to 75 kΩ, high voltages 5 kV to 65 kV applied to power line L4 can be lowered to approximately several volts at connection node N10. Though a configuration in which ten resistors are employed as step-down resistors RF1 to RF10 is illustrated in FIG. 2, the number of resistors may be set to a number other than ten so long as lowering to a desired voltage can be achieved.

Capacitors CF1 to CF10 are connected in parallel to resistors RF1 to RF10, respectively. Capacitor C10 is connected in parallel to resistor R10, between connection node N10 and ground potential GND.

Low-pass filter 141 includes a resistor R11 having one end connected to connection node N10 and a capacitor C11 connected between the other end of resistor R11 and ground potential GND. Low-pass filter 141 allows passage of a signal in a frequency band lower than a cut-off frequency determined by resistor R11 and capacitor C11. The signal having passed through low-pass filter 141 is supplied to high-pass filter 142 and also used as a signal FBK for feedback control in high-voltage power supply unit 120.

High-pass filter 142 includes a capacitor C12 having one end connected to the other end of resistor R11 and a resistor R12 connected between the other end of capacitor C12 and ground potential GND. High-pass filter 142 allows passage of a signal in a frequency band higher than a cut-off frequency determined by resistor R12 and capacitor C12.

Operational amplifier OP2 is a voltage follower type operational amplifier. Operational amplifier OP2 has a non-inverting input connected to the other end of capacitor C12 in high-pass filter 142, with resistor R15 being interposed. Operational amplifier OP2 has an inverting input connected to an output terminal of operational amplifier OP2. Operational amplifier OP2 functions as a buffer and plays a role to separate amplifier 143 and a circuit following the same. Resistor R15 is a protective resistor that prevents an excessively large current from flowing to operational amplifier OP2.

If high-pass filter 142 and amplifier 143 are directly connected to each other, resistor R12 of high-pass filter 142 and a resistor R13 of amplifier 143 appear to electrically be in parallel and hence, a combined resistance of resistor R12 and resistor R13 may cause such a situation that the cut-off frequency of high-pass filter 142 is not set to a frequency as designed. Therefore, in the circuit in FIG. 2, operational amplifier OP2 is arranged between high-pass filter 142 and amplifier 143 to electrically isolate high-pass filter 142 and amplifier 143 from each other. If a resistance value of each resistor is designed in consideration of the situation as above, operational amplifier OP2 does not necessarily have to be provided.

Amplifier 143 includes an operational amplifier OP1 and resistors R13 and R14. Resistor R13 has one end connected to the output terminal of operational amplifier OP2 and has the other end connected to one end of resistor R14. Resistor R13 has the other end connected also to an inverting input of operational amplifier OP1. Operational amplifier OP1 has a non-inverting input connected to ground potential GND and has an output terminal connected to the other end of resistor R14. In other words, operational amplifier OP1 and resistors R13 and R14 form an inverting amplifier. Resistor R14 has the other end connected further to comparator 144.

Comparator 144 compares the signal having passed through low-pass filter 141, high-pass filter 142, and amplifier 143 with the reference potential. For example, comparator 144 outputs a Hi (first-state) signal when the signal is lower than the reference potential, and outputs a Lo (second-state) signal when the signal is higher than the reference potential. When the output signal from comparator 144 makes transition from Hi to Lo, detection circuit 140 detects occurrence of electric discharge in the high-voltage circuit including X-ray tube 200. The output signal from comparator 144 may be set to Lo when an input signal is lower than the reference potential, and set to be Hi when the input signal is higher than the reference potential.

### Electric Discharge Detection Processing

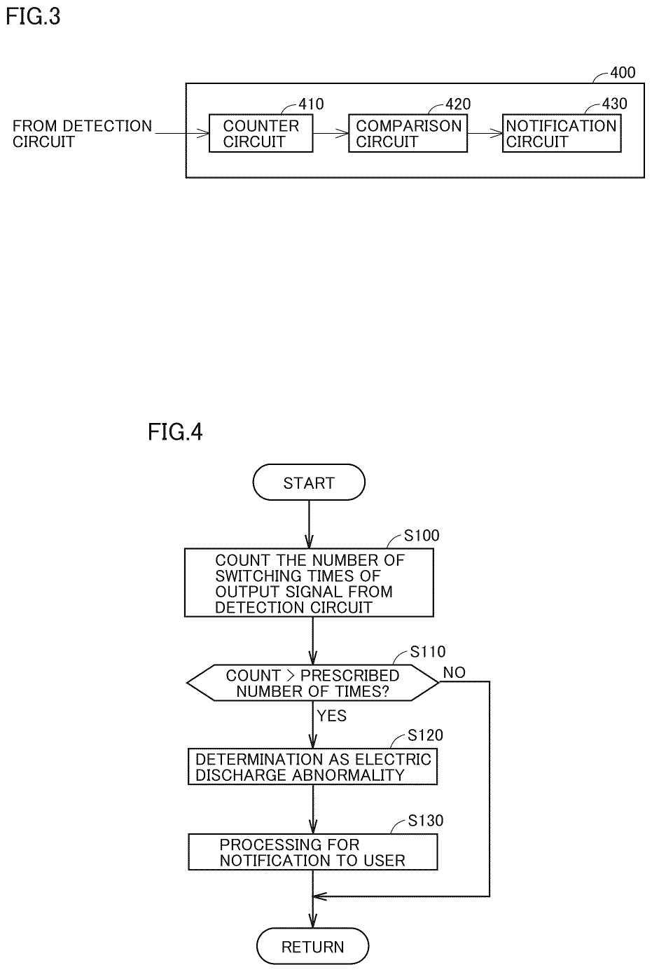

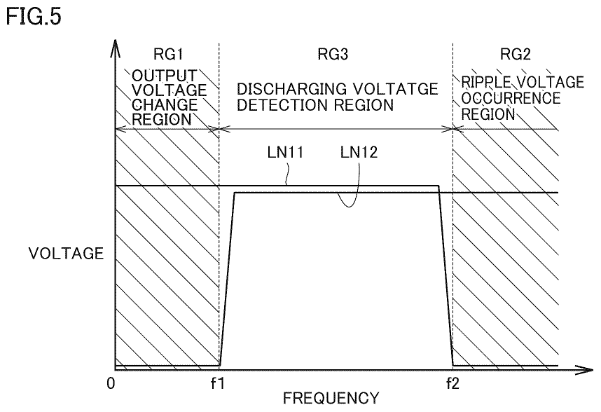

Electric discharge detection processing performed in control circuit 400 will now be described with reference to FIGS. 3 and 4. FIG. 3 is a functional block diagram of control circuit 400 in FIG. 1. FIG. 4 is a flowchart illustrating the electric discharge detection processing performed in control circuit 400.

Control circuit 400 includes a counter circuit 410, a comparison circuit 420, and a notification circuit 430. The circuits included in control circuit 400 are each implemented, for example, by a programmable logic controller (PLD) and/or a central processing unit (CPU).

In a step (the step being abbreviated as S below) 100, control circuit 400 counts, with counter circuit 410, the number of times of switching of the output signal from comparator 144 from Hi to Lo in detection circuit 140. That is, control circuit 400 counts the number of times of occurrence of electric discharge in the high-voltage circuit including X-ray tube 200. Then in S110, control circuit 400 compares, with comparison circuit 420, a count value obtained by counter circuit 410 with a prescribed reference value, and determines whether or not the count value has exceeded the reference value.

When the count value is equal to or smaller than the reference value (NO in S110), control circuit 400 skips following processing while it holds the count value. When the count value has exceeded the reference value (YES in S110), control circuit 400 has the process proceed to S120, makes determination as electric discharge abnormality, and outputs a signal to notification circuit 430. Notification circuit 430 is implemented by a display that can provide visual representation such as an indicator or a liquid crystal screen, or a buzzer or an apparatus capable of providing audio output or the like. Notification circuit 430 visually and/or aurally notifies the user of occurrence of a prescribed number of times or more of electric discharge (S130). The user can thus know a sign of abnormality and/or deterioration of the X-ray generator.

Determination as to electric discharge abnormality is not limited to determination based on comparison between the count value and the reference value, but may be determination based on variation in count every one hour. Specifically, determination as electric discharge abnormality may be made when tendency of increase in count every one hour is detected.

### Characteristics of Detection Circuit

In step-down of the voltage with the resistors connected in series such as resistors RF1 to RF10 in FIG. 2, resistors RF1 to RF10 and parasitic capacitances CS1 to CS10 of the resistors form a series-connected tenth-order low-pass filter. In this case, due to a time constant of the low-pass filter formed from the resistors and the parasitic capacitances, change of signal FBK for feedback is delayed when output from high-voltage power supply unit 120 varies.

Since a response speed of high-voltage power supply unit 120 and detection circuit 140 thus consequently becomes lower due to feedback control, variation in output provided from high-voltage power supply unit 120 becomes great due to variation in input, or load or influence by disturbance. Then, variation in intensity of X-rays emitted from the X-ray tube increases, which may affect stability of a result of analysis. Furthermore, due to delay in response by high-voltage power supply unit 120, it takes longer time until an output voltage from high-voltage power supply unit 120 reaches desired output when it is changed, and hence a time required for analysis consequently becomes longer.

When electric discharge or output short-circuiting occurs, on the other hand, charges stored in each parasitic capacitance flow into power line L4 through resistors RF1 to RF10. At this time, a higher voltage is applied to a resistor closer to power line L4 among resistors RF1 to RF10, which becomes a factor for failure and deterioration of that resistor. Since resistors RF1 to RF10 are components that affect accuracy and stability of the output voltage from high-voltage power supply unit 120, failure or deterioration of the resistors may also affect accuracy in analysis.

In particular, a high voltage portion of power supply apparatus 100 is generally sealed with a dielectric (molding material) higher in dielectric constant than air in order to ensure a substantial separation distance. Therefore, the parasitic capacitance produced by the molding material increases and influence by the above problems tends to be noticeable.

In order to solve such problems, in power supply apparatus 100 in the embodiment, capacitors CF1 to CF10 are connected in parallel to resistors RF1 to RF10, respectively. As capacitance values of these capacitors CF1 to CF10 connected in parallel are set to sufficiently be larger than parasitic capacitances CS1 to CS10, influence by parasitic capacitances CS1 to CS10 is ignorable and a high-frequency gain of voltage variation can be increased. Therefore, influence by lowering in response speed as described above and application of the high voltage to resistors RF1 to RF10 on the occurrence of electric discharge can be reduced. By way of example, if the parasitic capacitance produced in each resistor is assumed as 10 pF at the maximum, influence by the parasitic capacitances can be reduced, for example, by setting the capacitances of capacitors CF1 to CF 10 to approximately 100 pF.

In order to improve detection sensitivity in detection of electric discharge, the reference potential set in comparator 144 is required to be as low as possible to enable detection of minor voltage variation. On the other hand, it is also required to prevent erroneous detection as electric discharge, of voltage variation in a normal ordinary operation of the X-ray generator.

Two matters below may be factors for voltage variation in the ordinary operation. The first matter is voltage variation in intentional change of the output voltage, such as a step-up conversion operation at the time of start-up of the X-ray generator and setting change of the output voltage from high-voltage power supply unit 120. The second matter is voltage variation due to a ripple involved with a switching operation by a step-up conversion device included in high-voltage power supply unit 120.

In detection circuit 140 in the embodiment, since voltage variation involved with the ordinary operation is separated based on a frequency by low-pass filter 141 and high-pass filter 142, erroneous detection is prevented. Briefly, intentional change in output voltage is generally voltage variation gentler than voltage variation in electric discharge, and hence influence by the voltage variation is eliminated by high-pass filter 142. Voltage variation involved with the ripple is dependent on a switching frequency of the power conversion device and relatively higher in frequency than voltage variation in electric discharge. Therefore, influence by the voltage variation is eliminated by low-pass filter 141.

By way of example, in an example where a capacitance CCW value of a Cockcroft-Walton circuit included in high-voltage power supply unit 120 is set to 144 pF, a capacitance value of each of capacitors CF1 to CF 10 is set to 100 pF, and a resistance value of resistor R4 is set to 50 kΩ, a frequency of voltage variation at an output end of high-voltage power supply unit 120 on the occurrence of electric discharge is approximately 21 kHz. Change in setting of the output voltage, on the other hand, is gentle change as much as approximately 16 Hz, and a frequency of a ripple voltage is, for example, approximately 60 kHz.

Therefore, for example, by setting the cut-off frequency of high-pass filter 142 to 1.6 kHz and setting the cut-off frequency of low-pass filter 141 to 30 kHz, voltage variation due to electric discharge can be detected while eliminating influence by voltage variation with change in setting of the output voltage and influence by voltage variation involved with the ripple. The cut-off frequency of low-pass filter 141 may be set substantially to approximately 16 kHz, because influence by the ripple voltage should only be eliminated.

FIG. 5 is a diagram for illustrating a region where a discharging voltage is detected in the detection circuit in FIG. 1. In FIG. 5, the abscissa represents a frequency and the ordinate represents a voltage of a signal inputted to comparator 144. A line LN11 in FIG. 5 represents pass characteristics of low-pass filter 141 and a line LN12 represents pass characteristics of high-pass filter 142.

A cut-off frequency f1 of high-pass filter 142 is lower than a cut-off frequency f2 of low-pass filter 141 (f1<f2). As in FIG. 5, low-pass filter 141 and high-pass filter 142 form a band-pass filter having a frequency band between f1 and f2 as a pass band. In other words, a region RG1 in FIG. 5 is a region where voltage variation with change in output voltage may occur, and a region RG2 is a region where voltage variation may occur due to the ripple voltage. By appropriately adjusting cut-off frequencies f1 and f2 and setting a region RG3 where a discharging voltage is detected as in the above example, voltage variation due to electric discharge can be detected while eliminating influence by voltage variation with change in setting of the output voltage and influence by voltage variation involved with the ripple.

“Power line L4” in the embodiment corresponds to a “power feed line” in the present disclosure. “Resistor R10” in the embodiment corresponds to the “first resistive element” in the present disclosure. Each of “resistors RF1 to RF10” in the embodiment corresponds to the “second resistive element” in the present disclosure.

### First Modification

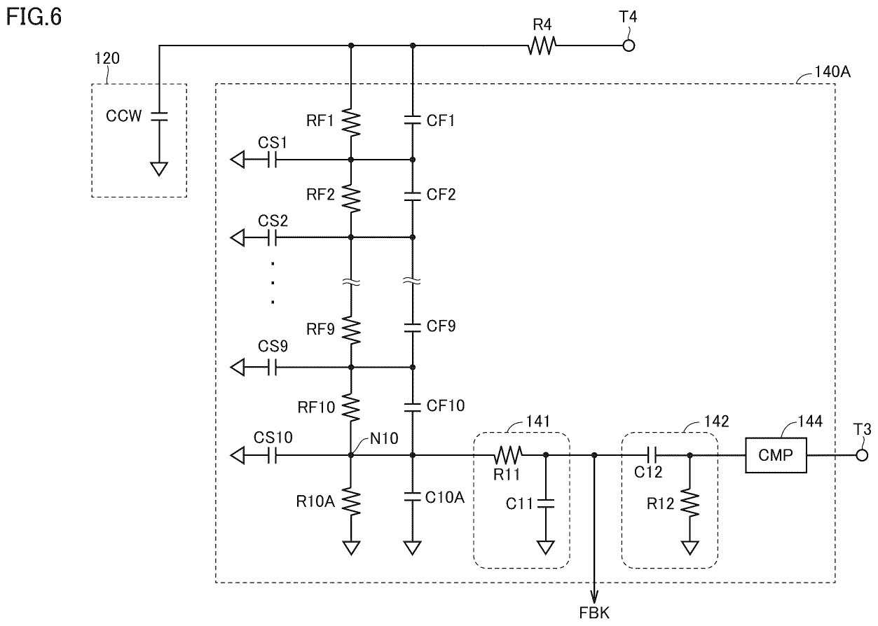

FIG. 6 is a diagram showing details of a detection circuit 140A in a first modification. Detection circuit 140A is configured in such a manner that resistor R10 and capacitor C10 in FIG. 2 are replaced with a resistor R10A and a capacitor C10A, respectively, and amplifier 143 is not provided. Description of an element in FIG. 6 the same as in FIG. 2 will not be repeated.

Referring to FIG. 6, capacitor C10A is smaller in capacitance value than capacitor C10. In the case of detection of electric discharge, voltage variation is usually instantaneous, which is a high-frequency signal in other words. Therefore, response to the high-frequency signal in the detection circuit (namely, high-frequency gain) is important. In the case of the high-frequency signal, the voltage is divided not by the resistor but by the capacitor. Therefore, by setting the capacitance value of capacitor C10A to be smaller than that of capacitor C10, an electric potential at connection node N10 becomes higher than in detection circuit 140.

Accordingly, by appropriately adjusting the capacitance value of capacitor C10A, amplifier 143 does not have to be provided. The number of components can thus be reduced, which can contribute to reduction in cost.

In the above first modification, the high-frequency gain is increased by setting the capacitance value of capacitor C10A to be smaller than that of capacitor C10. Instead, the high-frequency gain may be increased by increasing the capacitance values of capacitors CF1A to CF10A.

### Second Modification

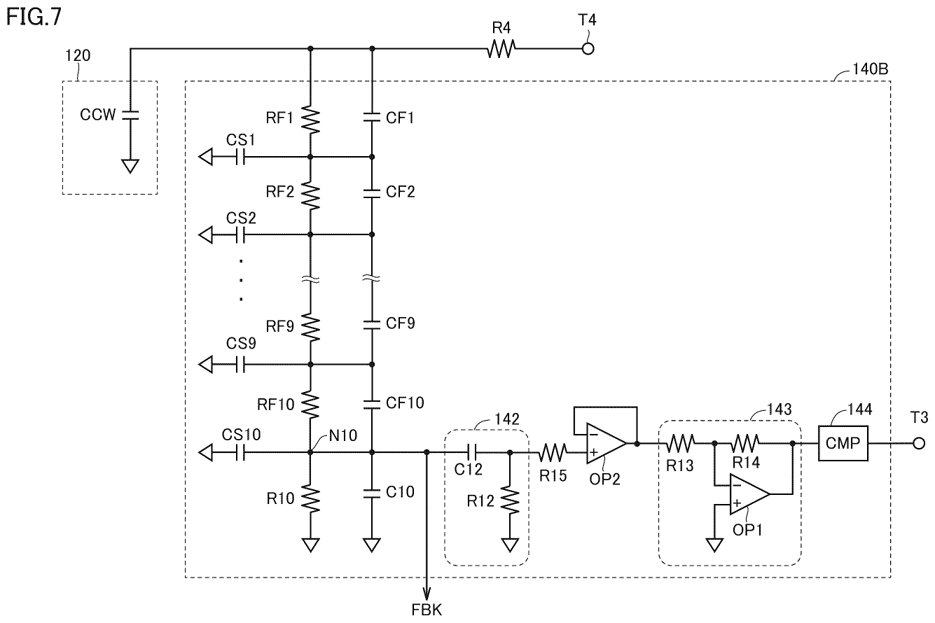

FIG. 7 is a diagram showing details of a detection circuit 140B in a second modification. Detection circuit 140B is configured not to include low-pass filter 141 in FIG. 2. Description of an element in FIG. 7 the same as in FIG. 2 will not be repeated.

The configuration in FIG. 7 can be applied to an apparatus where a level of a ripple voltage in a step-up conversion circuit in high-voltage power supply unit 120 is relatively low. This case can also contribute to reduction in cost by reduction in number of components.

In detection circuit 140B as well, amplifier 143 does not have to be provided by adjusting capacitor C10 as in the first modification.

High-pass filter 142 is provided to prevent erroneous detection in gentle change in output voltage from high-voltage power supply unit 120. In the electric discharge detection processing in control circuit 400, however, for example, by masking detection of electric discharge while the voltage increases from start-up of the X-ray generator to a prescribed voltage, or by masking detection of electric discharge during a period of change in voltage when a voltage setting value is changed, high-pass filter 142 can be omitted.

### Additional Aspects

Illustrative embodiments described above are understood by a person skilled in the art as specific examples of aspects below.

(Clause 1) An X-ray fluorescence spectrometer according to one aspect includes an X-ray tube, a detector, a power supply apparatus, and a control circuit. The X-ray tube includes a filament and a target and irradiates a sample with primary X-rays. The detector is configured to detect secondary X-rays generated from the sample. The power supply apparatus is configured to apply a tube voltage to the target. The control circuit is configured to detect occurrence of electric discharge in a high-voltage circuit including the X-ray tube. The power supply apparatus includes a high-voltage power supply unit that generates the tube voltage, a power feed line through which the tube voltage is transmitted from the high-voltage power supply unit to the target, and a detection circuit connected to the power feed line. The detection circuit is configured to detect voltage variation in the X-ray tube. The detection circuit includes a first resistive element having one end connected to a ground potential, a plurality of second resistive elements connected in series between the other end of the first resistive element and the power feed line, a plurality of capacitors connected in parallel to the plurality of second resistive elements, respectively, and a high-pass filter connected to the other end of the first resistive element. The control circuit is configured to detect occurrence of electric discharge in the high-voltage circuit based on a signal from the detection circuit.

According to the X-ray fluorescence spectrometer in Clause 1, the plurality of second resistive elements to which the capacitors are connected in parallel, respectively, are used to step down the tube voltage supplied from the high-voltage power supply unit to the X-ray tube, and occurrence of electric discharge in the high-voltage circuit including the X-ray tube is detected based on a signal resulting from passage of the reduced signal through the high-pass filter. As a result of reduction of the tube voltage by the second resistive elements to which the capacitors are connected in parallel, influence by the low-pass filter formed by the second resistive elements and parasitic capacitances is eliminated. Therefore, voltage variation of the tube voltage, that is, occurrence of electric discharge, can be detected with high responsiveness. Furthermore, as a result of passage of the reduced signal through the high-pass filter, erroneous detection as electric discharge, of gentle voltage variation that may occur in an ordinary analysis operation can be suppressed. Since a component adapted to a relatively low voltage can be employed for an element for the detection circuit, accuracy in detection of electric discharge can be improved while avoiding increase in cost.

(Clause 2) In the X-ray fluorescence spectrometer described in Clause 1, the detection circuit further includes an amplifier that amplifies a signal that has passed through the high-pass filter, the amplifier being provided in a path that connects the other end of the first resistive element and the control circuit.

According to the X-ray fluorescence spectrometer in Clause 2, a voltage level of the reduced signal can be raised by amplification by the amplifier, of the signal obtained by reduction of the tube voltage by the second resistive elements, after the signal passes through the high-pass filter. Therefore, electric discharge can be detected even when voltage variation is minor.

(Clause 3) In the X-ray fluorescence spectrometer described in Clause 1, the detection circuit further includes a low-pass filter provided in a path that connects the other end of the first resistive element and the control circuit, the low-pass filter being connected in series to the high-pass filter. The high-pass filter is lower in cut-off frequency than the low-pass filter.

According to the X-ray fluorescence spectrometer in Clause 3, influence by noise higher in frequency than electric discharge, such as a ripple voltage generated in the high-voltage power supply unit, can be eliminated by application of the low-pass filter higher in cut-off frequency than the high-pass filter. Therefore, accuracy in detection of electric discharge can further be improved.

(Clause 4) In the X-ray fluorescence spectrometer described in Clause 3, the detection circuit further includes an amplifier that amplifies a signal having passed through the high-pass filter and the low-pass filter, the high-pass filter and the low-pass filter being provided in the path that connects the other end of the first resistive element and the control circuit.

According to the X-ray fluorescence spectrometer in Clause 4, the voltage level of the reduced signal can be raised using amplification by the amplifier, of the signal obtained by reduction of the tube voltage using the second resistive elements, after the signal passes through the high-pass filter and the low-pass filter. Therefore, electric discharge can be detected even when voltage variation is minor.

(Clause 5) In the X-ray fluorescence spectrometer described in any one of Clauses 1 to 4, the detection circuit further includes a comparator configured to compare a signal having passed through the high-pass filter with a reference value. The control circuit is configured to detect occurrence of electric discharge in the high-voltage circuit based on an output signal from the comparator.

(Clause 6) In the X-ray fluorescence spectrometer described in Clause 5, the comparator changes the output signal from a first state to a second state when the signal having passed through the high-pass filter exceeds the reference value. The control circuit is configured to determine that electric discharge has occurred when the output signal from the comparator changes to the second state.

(Clause 7) In the X-ray fluorescence spectrometer described in Clause 6, the control circuit is configured to give a notification to a user when a prescribed number of times of electric discharge have been detected.

According to the X-ray fluorescence spectrometer in Clause 7, by notifying the user of a prescribed number of times of occurrence of electric discharge, the user can appropriately recognize the sign of abnormality or deterioration of an X-ray generator.

(Clause 8) A power supply apparatus according to one aspect applies a tube voltage to an X-ray tube including a filament and a target. The power supply apparatus includes a high-voltage power supply unit that generates the tube voltage, a power feed line through which the tube voltage is transmitted from the high-voltage power supply unit to the target, and a detection circuit connected to the power feed line. The detection circuit is configured to detect voltage variation in a high-voltage circuit including the X-ray tube. The detection circuit includes a first resistive element having one end connected to a ground potential, a plurality of second resistive elements connected in series between the other end of the first resistive element and the power feed line, a plurality of capacitors connected in parallel to the plurality of second resistive elements, respectively, a high-pass filter connected to the other end of the first resistive element, and a comparator configured to compare a signal that has passed through the high-pass filter with a reference value.

(Clause 9) An X-ray fluorescence spectrometer according to one aspect includes an X-ray tube, a detector, a power supply apparatus, and a control circuit. The X-ray tube includes a filament and a target and is configured to irradiate a sample with primary X-rays. The detector is configured to detect secondary X-rays generated from the sample. The power supply apparatus is configured to apply a tube voltage to the target. The control circuit is configured to detect occurrence of electric discharge in a high-voltage circuit including the X-ray tube. The power supply apparatus includes a high-voltage power supply unit that generates the tube voltage, a power feed line through which the tube voltage is transmitted from the high-voltage power supply unit to the target, and a detection circuit connected to the power feed line. The detection circuit is configured to detect voltage variation in the high-voltage circuit. The detection circuit includes a first resistive element having one end connected to a ground potential, a plurality of second resistive elements connected in series between the other end of the first resistive element and the power feed line, and a plurality of capacitors connected in parallel to the plurality of second resistive elements, respectively. The control circuit is configured to detect occurrence of electric discharge in the high-voltage circuit based on a signal from the detection circuit when a rate of change of the signal from the detection circuit is equal to or higher than a prescribed rate.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. An X-ray fluorescence spectrometer comprising:
an X-ray tube including a filament and a target, the X-ray tube being configured to irradiate a sample with primary X-rays;
a detector that detects secondary X-rays generated from the sample;
a power supply apparatus that applies a tube voltage to the target; and
a control circuit that detects occurrence of electric discharge in a high-voltage circuit including the X-ray tube, wherein
the power supply apparatus includes
a high-voltage power supply unit that generates the tube voltage,
a power feed line through which the tube voltage is transmitted from the high-voltage power supply unit to the target, and
a detection circuit connected to the power feed line, the detection circuit being configured to detect voltage variation in the high-voltage circuit,
the detection circuit includes
a first resistive element having one end connected to a ground potential,
a plurality of second resistive elements connected in series between the other end of the first resistive element and the power feed line,
a plurality of capacitors connected in parallel to the plurality of second resistive elements, respectively, and
a high-pass filter connected to the other end of the first resistive element, and
the control circuit is configured to detect occurrence of electric discharge in the high-voltage circuit based on a signal from the detection circuit.

2. The X-ray fluorescence spectrometer according to claim 1, wherein
the detection circuit further includes an amplifier that amplifies a signal that has passed through the high-pass filter, the amplifier being provided in a path that connects the other end of the first resistive element and the control circuit.

3. The X-ray fluorescence spectrometer according to claim 1, wherein
the detection circuit further includes a low-pass filter provided in a path that connects the other end of the first resistive element and the control circuit, the low-pass filter being connected in series to the high-pass filter, and
the high-pass filter is lower in cut-off frequency than the low-pass filter.

4. The X-ray fluorescence spectrometer according to claim 3, wherein
the detection circuit further includes an amplifier that amplifies a signal that has passed through the high-pass filter and the low-pass filter, the high-pass filter and the low-pass filter being provided in the path that connects the other end of the first resistive element and the control circuit.

5. The X-ray fluorescence spectrometer according to claim 1, wherein
the detection circuit further includes a comparator configured to compare a signal having passed through the high-pass filter with a reference value, and
the control circuit is configured to detect occurrence of electric discharge in the high-voltage circuit based on an output signal from the comparator.

6. The X-ray fluorescence spectrometer according to claim 5, wherein
the comparator is configured to change the output signal from a first state to a second state when the signal having passed through the high-pass filter exceeds the reference value, and
the control circuit is configured to determine that electric discharge has occurred when the output signal from the comparator changes to the second state.

7. The X-ray fluorescence spectrometer according to claim 6, wherein
the control circuit is configured to give a notification to a user when a prescribed number of times of electric discharge have been detected.

8. A power supply apparatus that applies a tube voltage to an X-ray tube including a filament and a target, the power supply apparatus comprising:
a high-voltage power supply unit that generates the tube voltage;
a power feed line through which the tube voltage is transmitted from the high-voltage power supply unit to the target; and
a detection circuit connected to the power feed line, the detection circuit being configured to detect voltage variation in a high-voltage circuit including the X-ray tube, wherein
the detection circuit includes
a first resistive element having one end connected to a ground potential,
a plurality of second resistive elements connected in series between the other end of the first resistive element and the power feed line,
a plurality of capacitors connected in parallel to the plurality of second resistive elements, respectively,
a high-pass filter connected to the other end of the first resistive element, and
a comparator configured to compare a signal that has passed through the high-pass filter with a reference value.
